(19) United States
(12) Patent Application Publication
(10) Pub. No.: US 2022/0002963 A1
(43) Pub. Date: Jan. 6, 2022

(54) Geosynthetic Clay Liners and Methods of Manufacturing

(71) Applicant: Halliburton Energy Services, Inc., Houston, TX (US)

(72) Inventor: Eric Benjamin Frantz, Houston, TX (US)

(73) Assignee: Halliburton Energy Services, Inc., Houston, TX (US)

(21) Appl. No.: 16/758,324

(22) PCT Filed: Jun. 12, 2019
(86) PCT No.: PCT/US2019/036720

§ 371 Date: Apr. 22, 2020

(51) Int. Cl. E02D 31/00; C09D 5/03; B05D 5/02; C09D 1/02; B05D 1/02; B05D 7/00; B05D 7/02

(52) U.S. Cl. CPC E02D 31/004; C09D 5/03; B05D 5/02; C09D 1/02; B05D 1/02; B05D 2256/00; B05D 7/02; B05D 2201/02; E02D 2300/0093; E02D 2300/0095; B05D 7/52

(57) ABSTRACT

A geosynthetic clay liner (GCL). The GCL may include a substrate layer, a bentonite layer applied onto the substrate layer, and a water-soluble polymer suspended in a non-aqueous medium and spray-applied over the bentonite layer.

### BACKGROUND

Low permeability barriers are used to separate fluids containing high concentrations of unwanted materials from the surrounding environment in fly-ash repositories, industrial mineral and metal mining sites, hydrocarbon wellsites, hydrocarbon containment sites, and coal burning power plants. Low permeability barriers may also be used in heap leach ponds, bioreactor landfills, municipal solid waste landfills, hazardous waste landfills, construction and demolition landfills, areas requiring animal waste containment, and agricultural and landscaping applications. In some applications, multiple low permeability barriers may be layered over one another to provide one or more secondary low permeability barriers.

As an example of a low permeability barrier, clay materials, such as bentonite, are used in a geosynthetic clay liner (“GCL”) that lines these areas to inhibit the unwanted migration of materials into the surrounding environment. A water-soluble polymer is also added to decrease the permeability of the GCL. The polymers are incorporated into the GCL in a powder form either by mixing the powdered water-soluble polymer into the bentonite as the bentonite is applied to a substrate layer or by pre-blending the powdered water-soluble polymer with the bentonite prior to application. However, such methods can lead to variances in the concentration of the polymer within the GCL. Additionally, pre-blending the water-soluble polymer can lead to loss of the water-soluble material during blending, packaging, and application of the bentonite/polymer mixture. In both cases, the resulting GCL may have areas where the permeability is higher than the intended permeability of the GCL.

### BRIEF DESCRIPTION OF THE DRAWINGS

Embodiments of the geosynthetic clay liner are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a schematic diagram of a wellsite, according to one or more embodiments;

FIG. 2 is an embodiment of a GCL with a water-soluble polymer being applied to a bentonite layer;

FIG. 3 is an embodiment of a GCL with a water-soluble polymer being applied to a bentonite layer; and

FIG. 4 a schematic diagram of a polymer solution being applied to a GCL at a wellsite, according to one or more embodiments disclosed.

### DETAILED DESCRIPTION

The present disclosure provides a geosynthetic clay liner (“GCL”). The GCL lines the base of fluid retention ponds to inhibit the unwanted migration of materials into the surrounding environment.

In this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. Additionally, as used herein, the term “about,” when used in conjunction with a target value, means within a value 10% of the target value.

As used herein, a water soluble polymer refers to a polymer that contains less than about 1% of material that is not water soluble.

The present disclosure relates to a GCL that includes a substrate layer, a bentonite layer, and a water-soluble polymer. The GCL may be used to line fluid retention ponds, such as frac ponds, to inhibit fluids from unwanted migration into the surrounding environment, as described above. Possible unwanted materials include, for example, monovalent, divalent and other multivalent cations and anions.

For the substrate layer, the GCL may include a geomembrane substrate layer made from high density polyethylene (“HDPE”). In other examples, the geomembrane substrate layer may be made from low density polyethylene (“LDPE”), liner low density polyethylene (“LLDPE”), polypropylene, polyvinylchloride (“PVC”), thermoplastic olefinic elastomers (“TPO”), ethylene propylene diene monomer (“EPDM”), or blends thereof.

Alternatively, the GCL substrate layer may include a geotextile made from woven or unwoven polypropylene, polyester, or blends thereof. A coating or geofilm may also be applied to the geotextile substrate layer. Possible coatings include, but are not limited to, polypropylene or polyurethane. Geofilms may also be laminated to the substrate layer and are may be made from HDPE, LDPE, LLDPE, polypropylene, PVC, TPO, EPDM, or blends thereof, for example. A second layer of geotextile material may cover a bentonite layer, as described below, and be attached to the geotextile substrate layer through sewing, heat bonding, or other methods of bonding geotextiles known to one skilled in the art. The second geotextile layer may be a woven or non-woven nylon, polypropylene, polyester, or blend thereof.

Bentonite is then applied to the substrate layer via methods known to one skilled in the art, such as by an auger driven feeder or any other suitable means. The bentonite that makes up the bentonite layer may be a granular bentonite that ranges in size from about 8 mesh to about 30 mesh. This means that about 80% or more of the bentonite will pass through a screen of the respective mesh size. However, the present disclosure is not thereby limited. In other examples, the bentonite may be larger than 8 mesh or smaller than 30 mesh. Additionally, a compacted powdered bentonite, i.e., bentonite that will pass through a 100 mesh or smaller screen, may also be used.

Adhesives, such as polyvinyl acetates or polyurethane, may be used to adhere the bentonite to the substrate layer. Alternatively, the bentonite may be deposited onto the substrate layer without the use of adhesive. Multiple layers of bentonite may also be used to build up the bentonite layer to the desired thickness resulting from a clay loading rate of about 0.5 lb/ft² to 1.5 lb/ft². However, the present disclosure is not thereby limited. In other examples, the bentonite layer may have a thickness resulting from a clay loading rate that is less than 0.5 lb/ft² or a thickness resulting from a clay loading rate that is greater than 1.5 lb/ft². To do so, adhesive may be applied to the bentonite deposited on the substrate layer and additional bentonite is adhered to the initial bentonite layer using adhesives. This process is then repeated until the bentonite layer reaches the desired thickness.

In addition to or in place of the bentonite, palygorskite-attapulgite, sepiolite, vermiculite, illite, muscovite, biotite, Fuller's earth, cookeite, bulk clay, ball clay, halloysite, flint clay, montmorillonite, smectite, an illite, a kaolinite, a zeolite tectosilicate, analcime, chabazite, clinoptilolite, erionite, ferrierite, heulandite, laumontite, mordenite, phillipsite natrolite, stilbite, scolecite, nontronite, bentonite, hectorite, smectite, swellable fluoromica, montmorillonite, beidellite, saponite, kaolin, any cation exchanged version thereof, and any combination thereof may be deposited on the substrate layer.

Once the bentonite layer is applied to the substrate layer, the bentonite layer may be spray-coated with a solution of water-soluble polymer suspended in a non-aqueous medium. The water-solubility of the polymer improves the incorporation of the polymer into the bentonite as the bentonite hydrates and swells when it comes into contact with an aqueous fluid. If multiple layers of bentonite are adhered together, the solution may be sprayed on each layer of bentonite as it is applied. Alternatively, the solution may be sprayed on select layers of bentonite or only the top layer of bentonite. Depending on the constituents, the solution may be dried after application to remove any volatile carriers from the solution using any acceptable method known to one skilled in the art.

The non-aqueous medium may be any of a number of non-aqueous medium that will not cause the bentonite to swell as the solution is sprayed onto the bentonite, such as, but not limited to, mineral oil, another oil-based fluid, a synthetic fluid, or volatile carriers. The water-soluble polymer may be any of a number of water-soluble polymers that, when applied to the bentonite layer, reduces the permeability of the bentonite layer, such as, but not limited to, a biopolymer, a synthetic polymer, and/or a crosslinkable organic polymer.

For example, possible biopolymers that may be combined with the non-aqueous medium include, but are not limited, to starches, gums, celluloses and other polysaccharides derived from either natural feedstocks or synthetically prepared using controlled biological processes, and chemical derivatives thereof with varying degrees of substitution, ionic charge and molecular weight. Possible synthetic polymers include, but are not limited to, a polyacrylamide, a polyalkylacrylamide, polyacrylic acid, polyvinyl alcohol, polyamide, polyamine, polyvinylpyrrolidone, polyalkyl glycols, polymethacrylates, and polymethacrylamides. Included are all water soluble vinyl polymers such as polyacrylate, polyacetic acid, poly(vinylidene) chloride, polyacrylonitrile, and sulfonated water soluble polymers.

Additionally, crosslinkable organic polymers may also be used in GCLs. The crosslinkable organic polymers are selected from the group consisting of a polyacrylamide; an acrylamide copolymer; an acrylamide-co-t-butylacrylate copolymer; a 2-acrylamido-2-methylpropane sulfonic acid/acrylamide copolymer; a sulfonated styrene/maleic anhydride copolymer;

a vinylpyrrolidone/2-acrylamido-2-methylpropane sulfonic acid/acrylamide terpolymer; a 2-acrylamido-2-methylpropane sulfonic acid/N—N-dimethylacrylamide/acrylamide terpolymer; a polyketone; any derivative thereof; and any combination thereof. Additionally, copolymers comprising at least one of the foregoing may be suitable. As used herein, the term “copolymer” encompasses polymers with two or more monomeric units, e.g., alternating copolymers, statistic copolymers, random copolymers, periodic copolymers, block copolymers (e.g., diblock, triblock, and so on), terpolymers, graft copolymers, branched copolymers, star polymers, and the like, or any hybrid thereof.

Multiple solutions comprising different water-soluble polymers may also be applied to the bentonite layer. Additional materials, such as superabsorbent polymer that may aid in water swelling, sodium carbonate that may help remove calcium from water, and chelating agents that may help remove non-monovalent cations from water and protect the bentonite from being converted from the native sodium form, may also be applied to the bentonite layer or the geomembrane substrate layer to enhance the performance of the GCL. Further, the bentonite may be coated with the solution or solutions of water-soluble polymer prior to being formed into the bentonite layer.

The bentonite may also be blended with additional materials, such as organically modified clay, sodium carbonate, sodium bicarbonate, activated charcoal, superabsorbent polymer, latex polymer, diatomaceous earth, zeolites, chelating agents, or cation exchange resin prior to being applied to the substrate layer. These materials may help remove calcium from water, help remove non-monovalent cations from water and protect the bentonite from being converted from the native sodium form, aid in absorbing unwanted materials, and/or improve swelling of the bentonite.

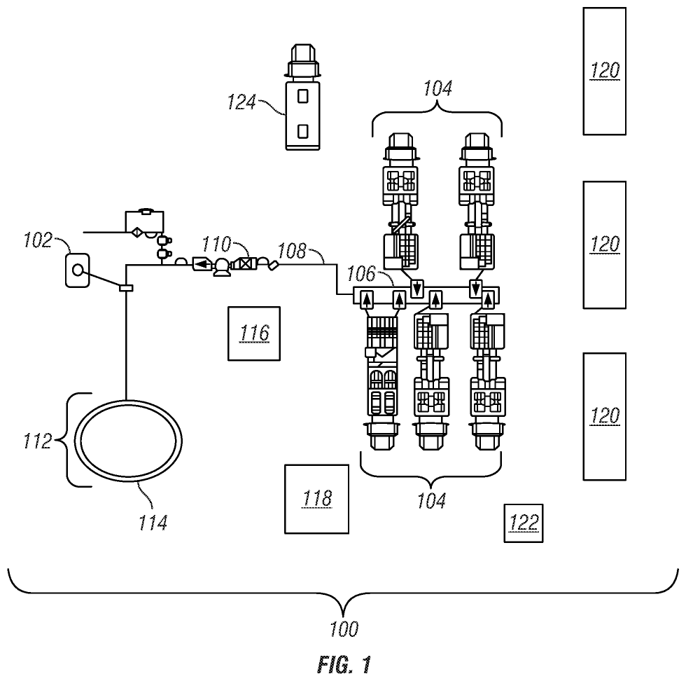

Turning now to FIG. 1, FIG. 1 is a schematic diagram of a wellsite 100, according to one or more embodiments of the present disclosure. Turning to FIG. 1, the wellsite includes a wellhead 102 positioned over a wellbore (not shown) and connected to one or more pieces of wellsite equipment, such as, pumping systems 104. The pumping systems 104 are connected to a manifold 106 and piping 108. Further, the piping 108 may include additional equipment, such as, valves 110 and flowmeters (not shown). This additional equipment may be used, e.g., to monitor and/or control the flow of fluid into a wellbore through the wellhead 102.

The wellhead is also connected to a frac pond 112 that is lined with a GCL 114. After the pumping systems 104 pump fracturing fluid downhole through the wellhead 102, the fracturing fluid is circulated back uphole and deposited in the frac pond 112. The GCL 114 lining the frac pond 112 restrains/inhibits (or use some other non-absolute term) the fracturing fluid from leaking through the GCL and out of the frac pond 112 and into the surrounding environment. The wellsite 100 may also include other fluid retention ponds (not shown) that are lined with GCLs (not shown) to restrain? fluid from leaking through the GCL into the surrounding environment.

The wellsite 100 may also include other pieces of equipment, such as, a generator 116, a blender 118, storage tanks 120 (three shown), a fluid distribution system 122, and a monitoring and control unit 124. The storage tanks 120 may contain fuel, wellbore fluids, proppants, diesel exhaust fluid, and/or other fluids. Although not shown, the fluid distribution system 122 is fluidly coupled to one or more pieces of wellsite equipment, such as, the pumping systems 104, the generator 116, the blender 118, or the monitoring and control unit 124. The fluid distribution system 122 may supply fluids, such as, fuel, diesel exhaust fluid, fracturing fluid, and/or other fluids, to the pieces of wellsite equipment 104, 116, 118 from one or more of the storage tanks 120.

In one or more embodiments, all or a portion of the aforementioned wellsite equipment may be mounted on trailers. However, the wellsite equipment may also be free standing or mounted on a skid.

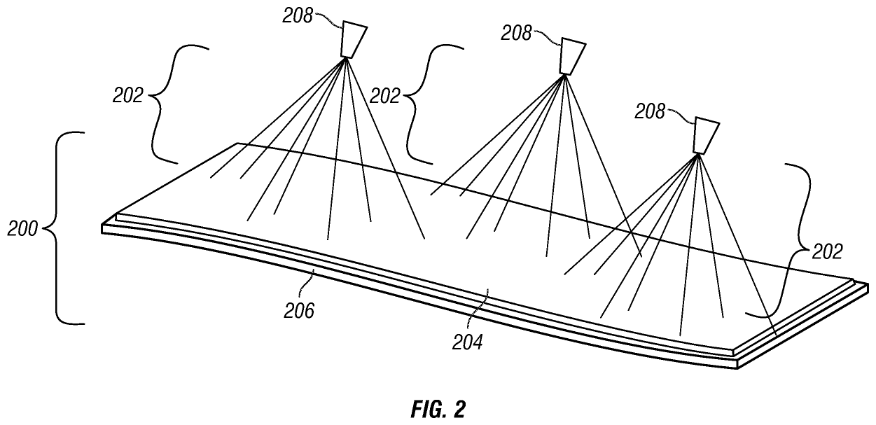

FIG. 2 is an embodiment of a GCL 200 with a water-soluble polymer solution 202 being applied to a bentonite layer 204. In this embodiment, the water-soluble polymer solution 202 is being spray-applied to the bentonite layer 204. The GCL 200 also includes a geomembrane substrate layer 206 and the bentonite layer 204, as described above, is adhered to the geomembrane substrate layer 206 using an adhesive.

FIG. 2 illustrates a non-limiting embodiment whereby a spray system 208 is used to coat the bentonite with a solution 202 of water-soluble polymer suspended in a non-aqueous medium, as described above. If multiple layers of bentonite are adhered together, the solution 202 may be sprayed on each layer of bentonite as it is applied. Alternatively, the solution 202 may be sprayed on select layers of bentonite or only the top layer of bentonite.

Multiple solutions 202 comprising different water-soluble polymers may also be applied to the bentonite layer 204 via the spray system 208. Additional materials, such as superabsorbent polymer, latex polymer, and chelating agents, may also be applied to the bentonite layer 204 or the geomembrane substrate layer 206 using the spray system 208 to enhance the performance of the GCL 200.

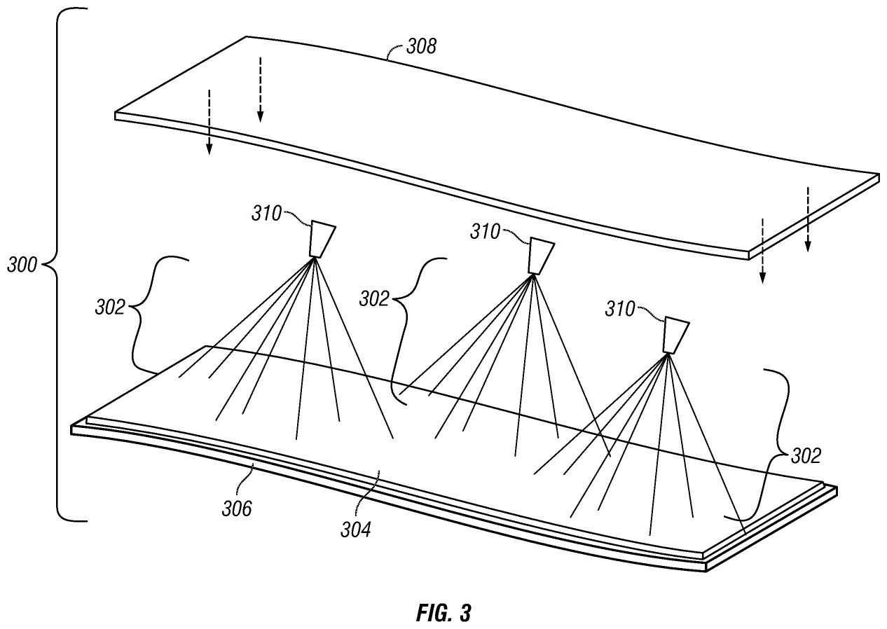

FIG. 3 is another embodiment of a GCL 300 with a water-soluble polymer solution 302 being applied to a bentonite layer 304. The GCL 300 may be used to line fluid retention ponds to inhibit unwanted migration of materials into the surrounding environment, as described above. The GCL 300 includes a geotextile substrate layer 306, a bentonite layer 304 that is applied to the geotextile substrate layer 306, and a second geotexile layer 308. A spray system 310 is then used to coat the bentonite with the solution 302 of water-soluble polymer suspended in a non-aqueous medium as described above, as described above. sAfter the solution 302 is applied to the bentonite, the second geotextile layer 308 is attached to the geotextile substrate layer 306 through sewing, heat bonding, or other methods of bonding geotextiles.

A second bentonite layer (not shown) may be applied to the second geotextile layer 308 after the geotextile substrate layer 306 and the second geotextile layer 308 are attached. The solution 302 would then be applied to the second bentonite layer and a third geotextile layer (not shown) would be attached to the second geotextile layer 308. This process may be repeated additional times as necessary until a desired permeability for the GCL 300 is reached.

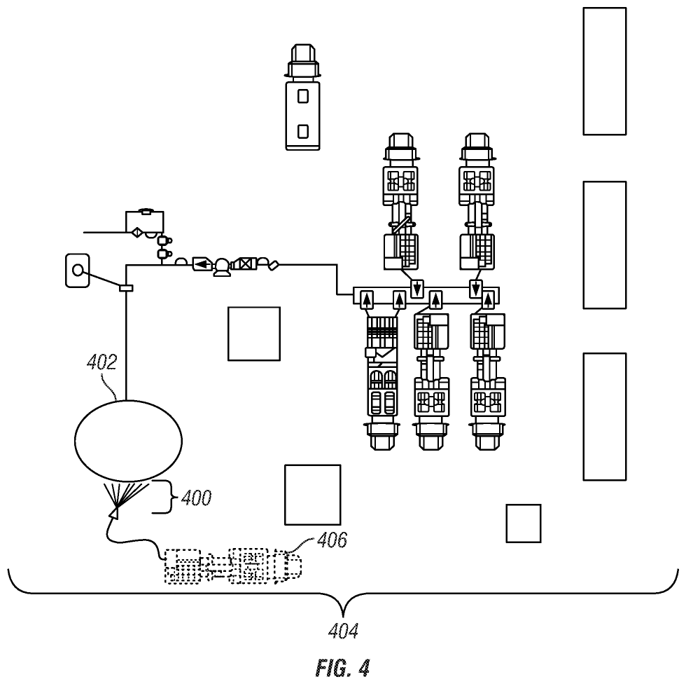

Referring now to FIG. 4, FIG. 4 is a schematic diagram of a polymer solution 400 being applied to an embodiment of a GCL 402 at a wellsite 404. As shown in FIG. 4, a spray system 406 is used to coat a GCL 402 with a solution 400 of water-soluble polymer suspended in a non-aqueous medium, as described above, after the GCL has been installed at a wellsite 404.

The spray system 406 may also be used to apply a solution comprising additional materials, such as superabsorbent polymer, latex polymer, and/or chelating agents to the GCL 402. The spray system 406 may also be used to apply the solution 400 to a GCL 402 that has already been produced but has not yet been delivered or installed at a wellsite 404.

Further examples include:

Example 1 is a GCL that includes a substrate layer, a bentonite layer applied onto the substrate layer, and a water-soluble polymer suspended in a non-aqueous medium and spray-applied over the bentonite layer.

In Example 2, the embodiments of any preceding paragraph or combination thereof and further including wherein the water-soluble polymer includes at least one of biopolymers, synthetic polymers, or crosslinkable organic polymers.

In Example 3, the embodiments of any preceding paragraph or combination thereof and further including wherein the bentonite layer includes a granular bentonite having a size range of about 8 mesh to about 30 mesh.

In Example 4, the embodiments of any preceding paragraph or combination thereof and further including wherein the substrate layer includes a geomembrane comprising at least one of high density polyethylene, low density polyethylene, liner low density polyethylene, polypropylene, polyvinylchloride, thermoplastic olefinic elastomers, ethylene propylene diene monomer, or blends thereof.

In Example 5, the embodiments of any preceding paragraph or combination thereof and further including wherein the bentonite layer is adhered to the substrate layer.

In Example 6, the embodiments of any preceding paragraph or combination thereof and further including a geotextile layer disposed on top of the bentonite layer and the water-soluble polymer and that is attached to the substrate layer.

In Example 7, the embodiments of any preceding paragraph or combination thereof and further including wherein each of the substrate layer and the geotextile layer are either woven or non-woven, and each of the substrate layer and the geotextile layer includes at least one of nylon, polypropylene, polyester, or blends thereof.

In Example 8, the embodiments of any preceding paragraph or combination thereof and further including wherein the water-soluble polymer suspended in the non-aqueous medium is further spray-applied over the geotextile layer after the geotextile layer is attached to the substrate layer.

Example 9 is a method for manufacturing a GCL. The method includes applying a bentonite layer to a substrate layer. The method also includes spraying the bentonite layer with a solution comprising a water-soluble polymer suspended in a non-aqueous medium.

In Example 10, the embodiments of any preceding paragraph or combination thereof and further including wherein the water-soluble polymer includes at least one of biopolymers, synthetic polymers, or crosslinkable organic polymers.

In Example 11, the embodiments of any preceding paragraph or combination thereof and further including wherein the bentonite layer includes a granular bentonite having a size range of about 8 mesh to about 30 mesh.

In Example 12, the embodiments of any preceding paragraph or combination thereof and further including wherein the substrate layer includes a geomembrane comprising at least one of high density polyethylene, low density polyethylene, liner low density polyethylene, polypropylene, polyvinylchloride, thermoplastic olefinic elastomers, ethylene propylene diene monomer, or blends thereof.

In Example 13, the embodiments of any preceding paragraph or combination thereof and further including wherein applying the bentonite layer to the substrate layer includes adhering the bentonite layer to the substrate layer.

In Example 14, the embodiments of any preceding paragraph or combination thereof and further including disposing a geotextile layer on top of the bentonite layer after spraying the bentonite layer with the solution. The subject matter of Examples 9-11 can also include attaching the geotextile layer to the substrate layer.

In Example 15, the embodiments of any preceding paragraph or combination thereof and further including wherein each of the substrate layer and the geotextile layer are either woven or non-woven, and each of the substrate layer and the geotextile layer includes at least one of nylon, polypropylene, polyester, or blends thereof.

In example 16, the embodiments of any preceding paragraph or combination thereof and further including spraying the geotextile layer with the solution after the geotextile layer has been attached to the substrate layer.

Example 17 is a method of treating a GCL at a wellsite. The method includes installing a GCL in a frac pond at the wellsite. The method also includes spraying the GCL with a solution comprising a water-soluble polymer suspended in a non-aqueous medium.

In Example 18, the embodiments of any preceding paragraph or combination thereof and further including wherein the GCL includes a geomembrane substrate layer.

In Example 19, the embodiments of any preceding paragraph or combination thereof and further including wherein the GCL includes a geotextile substrate layer.

In Example 20, the embodiments of any preceding paragraph or combination thereof and further including wherein the water-soluble polymer includes at least one of biopolymers, synthetic polymers, or crosslinkable organic polymers.

One or more specific embodiments of the geosynthetic clay liner have been described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A geosynthetic clay liner (GCL) comprising:
a substrate layer;
a bentonite layer applied onto the substrate layer; and
a water-soluble polymer suspended in a non-aqueous medium and spray-applied over the bentonite layer.

2. The GCL of claim 1, wherein the water-soluble polymer comprises at least one of biopolymers, synthetic polymers, or crosslinkable organic polymers.

3. The GCL of claim 1, wherein the bentonite layer comprises a granular bentonite having a size range of about 8 mesh to about 30 mesh.

4. The GCL of claim 1, wherein the substrate layer comprises a geomembrane comprising at least one of high density polyethylene, low density polyethylene, liner low density polyethylene, polypropylene, polyvinylchloride, thermoplastic olefinic elastomers, ethylene propylene diene monomer, or blends thereof.

5. The GCL of claim 4, wherein the bentonite layer is adhered to the substrate layer.

6. The GCL of claim 1, wherein the GCL further comprises a geotextile layer disposed on top of the bentonite layer and the water-soluble polymer and that is attached to the substrate layer.

7. The GCL of claim 6, wherein each of the substrate layer and the geotextile layer are either woven or non-woven, and each of the substrate layer and the geotextile layer comprises at least one of nylon, polypropylene, polyester, or blends thereof.

8. The GCL of claim 6, wherein the water-soluble polymer suspended in the non-aqueous medium is further spray-applied over the geotextile layer after the geotextile layer is attached to the substrate layer.

9. A method of manufacturing a GCL, the method comprising:
applying a bentonite layer to a substrate layer; and
spraying the bentonite layer with a solution comprising a water-soluble polymer suspended in a non-aqueous medium.

10. The method of claim 9, wherein the water-soluble polymer comprises at least one of biopolymers, synthetic polymers, or crosslinkable organic polymers.

11. The method of claim 9, wherein the bentonite layer comprises a granular bentonite having a size range of about 8 mesh to about 30 mesh.

12. The method of claim 9, wherein the substrate layer comprises a geomembrane comprising at least one of high density polyethylene, low density polyethylene, liner low density polyethylene, polypropylene, polyvinylchloride, thermoplastic olefinic elastomers, ethylene propylene diene monomer, or blends thereof.

13. The method of claim 12, wherein applying the bentonite layer to the substrate layer comprises adhering the bentonite layer to the substrate layer.

14. The method of claim 9, further comprising:
disposing a geotextile layer on top of the bentonite layer after spraying the bentonite layer with the solution; and
attaching the geotextile layer to the substrate layer.

15. The method of claim 14, wherein each of the substrate layer and the geotextile layer are either woven or non-woven, and each of the substrate layer and the geotextile layer comprises at least one of nylon, polypropylene, polyester, or blends thereof.

16. The method of claim 14, further comprising spraying the geotextile layer with the solution after the geotextile layer has been attached to the substrate layer.

17. A method of treating a GCL at a wellsite, the method comprising:
installing a GCL in a frac pond at the wellsite; and
spraying the GCL with a solution comprising a water-soluble polymer suspended in a non-aqueous medium.

18. The method of claim 17, wherein the GCL comprises a geomembrane substrate layer.

19. The method of claim 17, wherein the GCL comprises a geotextile substrate layer.

20. The method of claim 17, wherein the water-soluble polymer comprises at least one of biopolymers, synthetic polymers, or crosslinkable organic polymers.
